(19) United States
(12) Patent Application Publication
(10) Pub. No.: US 2012/0075524 A1
(43) Pub. Date: Mar. 29, 2012

(54) SYSTEM AND METHOD FOR FRAME RATE CONVERSION

(75) Inventor: Yeong Taeg Kim, Irvine, CA (US)

(73) Assignee: Samsung Electronics Co., Ltd., Suwon City (KR)

(21) Appl. No.: 12/890,424

(22) Filed: Sep. 24, 2010

(51) Int. Cl. H04N 7/01

(52) U.S. Cl. 348/441; 348/E07.083

(57) ABSTRACT

A system and method for frame rate conversion are disclosed. In one embodiment, the method comprises receiving, at the first device from a second device, input video having a first frame rate, receiving, at the first device from the second device, motion vector information associated with the input video, determining, at the first device, output video having a second frame rate different from the first frame rate, wherein the output video is based on the input video and the motion vector information, and displaying the output video.

### BACKGROUND

1. Field

The disclosure is related to video processing. More particularly, the disclosure is related to techniques for frame rate conversion using motion information received from an external source.

2. Description of the Related Technology

Multimedia processing systems, such as video encoders, may encode multimedia data using encoding methods based on international standards such as MPEG-x and H.26x standards. Such encoding methods generally are directed to compressing the multimedia data for transmission and/or storage. Compression is broadly directed to the process of removing redundancy from the data. In addition, video display systems may transcode or transform multimedia data for various purposes such as, for example, to ensure compatibility with display standards such as NTSC, HDTV, or PAL, to increase frame rate in order to reduce perceived motion blur, and to achieve smooth motion portrayal of content with a frame rate that differs from that of the display device. These transcoding methods may perform similar functions as the encoding methods for performing frame rate conversion, de-interlacing, etc.

A video signal may be described in terms of a sequence of pictures, which include frames (an entire picture), or fields (e.g., an interlaced video stream comprising fields of alternating odd or even lines of a picture). Multimedia processors, such as video encoders, may encode a frame by partitioning it into blocks or “macroblocks” of, for example, 16×16 pixels. The encoder may further partition each macroblock into subblocks. Each subblock may further comprise additional subblocks. For example, subblocks of a macroblock may include 16×8 and 8×16 subblocks. Subblocks of the 8×16 subblocks may include 8×8 subblocks, and so forth. Depending on context, a block may refer to either a macroblock or a subblock, or even a single pixel.

Video sequences may be received by a receiving device in a compressed format and subsequently be decompressed by a decoder in the receiving device. Video sequences may also be received in an uncompressed state. In either case, the video sequence is characterized at least by a frame rate, and a horizontal and vertical pixel resolution. Many times, a display device associated with the receiving device may require a different frame rate and/or pixel resolution. To accommodate this, video reconstruction of one or more video frames may be performed. Reconstruction of video frames may comprise estimating a video frame between two or more already received (or received and decompressed) video frames. The reconstruction may involve techniques known as motion estimation and motion compensation. Matching portions of video frames between two or more already received (or received and decompressed) frames are identified along with a motion vector that contains the relative locations of the matching blocks in the process of motion estimation. These matching blocks and motion vectors are then used to reconstruct portions of the intermediate frame by the process of motion compensation. Frame rate conversion, de-interlacing, and transcoding are examples of processes where decoder devices create new video data based on already available video data. In addition, these motion compensation techniques can use encoded data, such as motion vectors and residual error, as well as the reconstructed video data for estimating the newly created frames.

As noted above, reconstruction may involve techniques known as motion estimation and motion compensation. Motion compensation can use encoded data, such as motion vectors and residual error, generated during the motion estimation, for creating new intermediate frames. However, performing motion estimation can be computationally intensive and introduce additional delay between the reception of video and its display at a different frame rate. Reduction or elimination of this computation and delay while still achieving at least equivalent image quality is desirable.

### SUMMARY OF CERTAIN INVENTIVE ASPECTS

The systems and methods of the development each have several aspects, no single one of which is solely responsible for its desirable attributes. Without limiting the scope of this disclosure as expressed by the claims which follow, its more prominent features will now be discussed briefly. After considering this discussion, and particularly after reading the section entitled “Detailed Description of Certain Inventive Embodiments” one will understand how the sample features of this development provide advantages that include reduction or elimination of delay associated with motion estimation.

One aspect of the development includes a method of displaying video, the method comprising receiving, at a first device from a second device, input video having a first frame rate, receiving, at the first device from the second device, motion vector information associated with the input video, generating, at the first device, output video having a second frame rate different from the first frame rate, wherein the output video is based on the input video and the motion vector information, and displaying the output video.

Another aspect of the development includes a method of transmitting motion vector information, the method comprising generating video at a first device, generating motion vector information associated with the video at the first device, transmitting the video from the first device to a second device, and transmitting the motion vector information from the first device to the second device.

Another aspect of the development includes a first device for displaying video, the first device comprising a receiver configured to receive, at the first device from a second device, input video having a first frame rate and motion vector information associated with the input video, a processor configured to generate output video having a second frame rate different from the first frame rate, wherein the output video is based on the input video and the motion vector information, and a display configured to display the output video.

Another aspect of the development includes a first device for transmitting motion vector information, the first device comprising a processor configured to generate video and motion vector information associated with the video, and a transmitter configured to transmit the video and the motion vector information from the first device to a second device.

Another aspect of the development includes a first device for displaying video, the first device comprising means for receiving, at the first device from a second device, input video having a first frame rate, means for receiving, at the first device from the second device, motion vector information associated with the input video, means for generating, at the first device, output video having a second frame rate different from the first frame rate, wherein the output video is based on the input video and the motion vector information, and means for displaying the output video.

Another aspect of the development includes a first device for transmitting motion vector information, the first device comprising means for generating video at the first device, means for generating motion vector information associated with the video at the first device, means for transmitting the video from the first device to a second device, and means for transmitting the motion vector information from the first device to the second device.

Yet another aspect of the development includes a computer-readable storage medium having processor-executable instructions encoded thereon which, when executed by a processor, cause a first device to perform a method of displaying video, the method comprising receiving, at the first device from a second device, input video having a first frame rate, receiving, at the first device from the second device, motion vector information associated with the input video, generating, at the first device, output video having a second frame rate different from the first frame rate, wherein the output video is based on the input video and the motion vector information, and displaying the output video.

Yet another aspect of the development includes a computer-readable storage medium having processor-executable instructions encoded thereon which, when executed by a processor, cause a first device to perform a method of transmitting motion vector information, the method comprising generating video at the first device, generating motion vector information associated with the video at the first device, transmitting the video from the first device to a second device, and transmitting the motion vector information from the first device to the second device.

### BRIEF DESCRIPTION OF THE DRAWINGS

FIG. 1 is a functional block diagram of an exemplary system for displaying video, according to one embodiment of the system and method.

FIG. 2 is a functional block diagram of an exemplary system for displaying video, according to another embodiment of the system and method.

FIG. 3 is a functional block diagram illustrating an embodiment of a content receiver that may be used in the system illustrated in FIG. 2.

FIG. 4 is a functional block diagram illustrating an embodiment of a content source that may be used in the system illustrated in FIG. 2.

FIG. 5 is flowchart illustrating a method of displaying video.

FIG. 6 is a flowchart illustrating a method of transmitting motion information.

### DETAILED DESCRIPTION OF CERTAIN INVENTIVE EMBODIMENTS

The following detailed description is directed to certain specific sample aspects of the development. However, the development can be embodied in a multitude of different ways as defined and covered by the claims. In this description, reference is made to the drawings wherein like parts are designated with like numerals throughout.

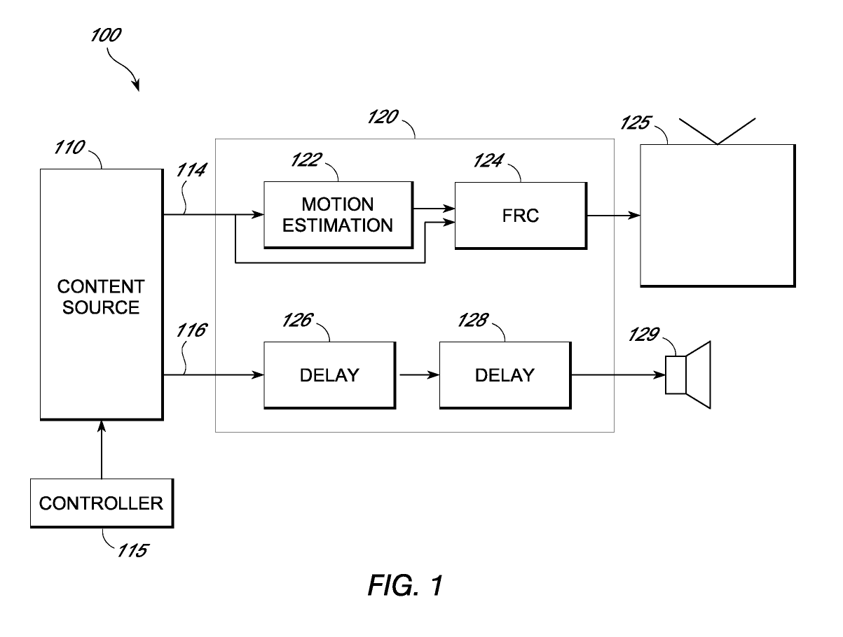

FIG. 1 is a functional block diagram of an exemplary system 100 for displaying video, according to one embodiment of the system and method. The system 100 includes a content source 110, a content receiver 120, and output devices including a display 125 for presenting video content and a speaker 129 for presenting audio content.

The content source 110 transmits content to the content receiver 120. The content can be generated in a processor of the content source 110 or retrieved by the content source 110 from a memory or other computer-readable medium of the content source 110. In one embodiment, the content source 110 generates content in real-time based on data indicative of user instructions received via a controller 115 and/or software stored on a computer-readable medium. In another embodiment, the content source 110 retrieves content from a computer-readable medium such as a video cassette, DVD, or Blu-ray disc.

The content source 110 can transmit video content via a first communication link 114 and audio content via a second communication link 116. The content receiver 120 receives the video content via the first communication link 114 and inputs the video content into a motion estimation module 122 which generates motion information based on the received video content. The motion information and the video content having a first frame rate are input into frame rate conversion module 124 which outputs interpolated video content having a second frame rate different from the first frame rate based on the received motion information and video content. The interpolated video content can be presented to a user via the display 125.

The content receiver 120 receives the audio content via the second communication link 116 and inputs the audio content into a first delay module 126 and a second delay module 128 which synchronizes the audio content with the interpolated video content. The synchronized audio content can be presented to the user via the speaker 129.

The content receiver 120 can perform additional processing on the video content and/or the audio content, such as decompression, noise reduction, brightness/contrast adjustment, color adjustment, or other processing.

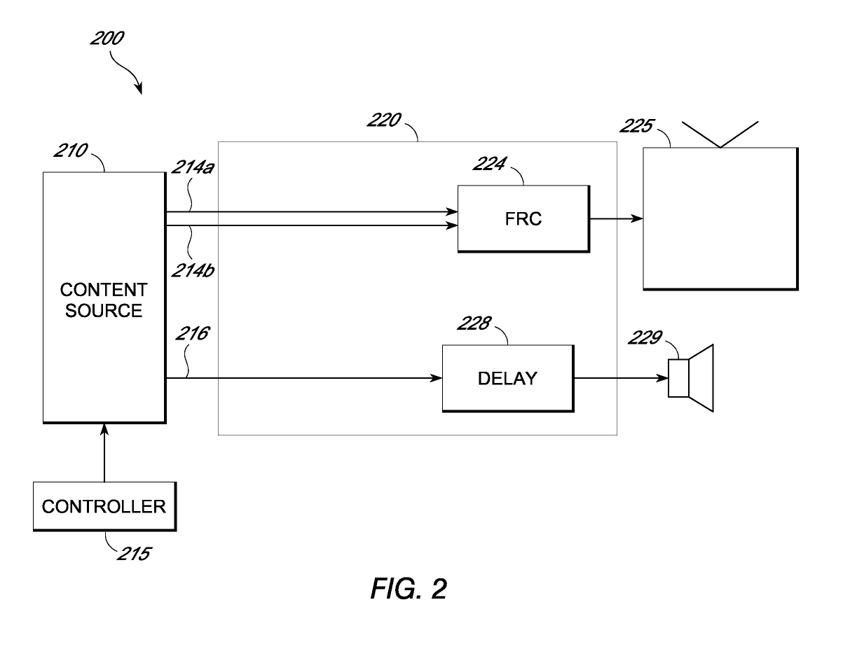

As mentioned above, the motion estimation module 122 generates motion information based on the received video content. The generation of motion information can be computationally intensive and can introduce additional delay between the reception of video and its display at a different frame rate. Accordingly, in another embodiment, illustrated in FIG. 2, motion information is received from a content source 210 rather than generated at a content receiver 220.

In one or more exemplary embodiments, the functions described herein, including but not limited to those performed by the delay modules 126, 128 and motion estimation module 122, can be implemented in hardware, software, firmware, or any combination thereof. If implemented in software, the functions may be stored on, or transmitted over as one or more instructions or code, a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

FIG. 2 is a functional block diagram of an exemplary system for displaying video, according to another embodiment of the system and method. The system 200 includes a content source 210, a content receiver 220, and output devices including a display 225 for presenting video content and a speaker 229 for presenting audio content.

As in the system 100 of FIG. 1, the content source 210 transmits content to the content receiver 220. The content can be generated in a processor of the content source 210 or retrieved by the content source 210 from a memory or other computer-readable medium of the content source 210. In one embodiment, the content source 210 generates content in real-time based on data indicative of user instructions received via a controller 215 and/or software stored on a computer-readable medium. In another embodiment, the content source 210 retrieves content from a computer-readable medium such as a video cassette, DVD, or Blu-ray disc.

The content source 210 can transmit video content via a first communication link 214a and audio content via a second communication link 116. Unlike the system 100 of FIG. 1, the content source 210 can transmit motion information associated with the video content via a third communication link 214b.

The motion information, like the content, can be generated in a processor of the content source 210 or retrieved by the content source 210 from computer-readable medium of the content source 210. In one embodiment, the content source 210 generates motion information in real-time based on data indicative of user instructions received via the controller 215 and/or software stored on a computer-readable medium. In another embodiment, the content source 210 retrieves motion information from a computer-readable medium such as a video cassette, DVD, or Blu-ray disc. In one embodiment, the content and the motion information are stored on the same computer-readable medium.

In one embodiment, the content source 210 is a gaming apparatus configured to generate content based on data indicative of user instructions received from the controller 215 and gaming software stored on a computer-readable medium. For example, the content source 210 can generate video content of an avatar of the user and when the user inputs instructions into the controller 215 for moving the avatar in a particular direction, the content source 210 generates video content of the avatar moving in that particular direction. Further, the content source 210 can generate motion information indicating that the avatar is moving in that particular direction. As another example, the content source 210 can generate video content of an avatar of the user having a projectile weapon and when the user inputs instructions into the controller 215 to fire the weapon, the content source 210 generates video content of a projectile moving away from the weapon in a particular direction. Further, the content source 210 can generate motion information indicative that the projectile is moving in that particular direction. The above examples are meant to be illustrative only and those of ordinary skill in the computer-generated graphical arts will appreciate other examples of generated content and motion information. The content receiver 220 receives the video content via the first communication link 214a and the motion information via the third communication link 214b. The motion information and the video content having a first frame rate are input into a frame rate conversion module 224 which outputs interpolated video content having a second frame rate different from the first frame rate based on the received motion information and video content. The interpolated video content can be presented to user via the display 225.

The content receiver 220 receives the audio content via the second communication link 216 and inputs the audio content into a delay module 228 which synchronizes the audio content with the interpolated video content. The synchronized audio content can be presented to the user via the speaker 229. The delay introduced by the delay module 228 to compensate for the video processing is expected to be less than the delay introduced by the first delay module 126 and second delay module 128 of FIG. 1.

As in the system of FIG. 1, the content receiver 220 can perform additional processing on the video content and/or the audio content, such as decompression, noise reduction, brightness/contrast adjustment, color adjustment, or other processing.

In one embodiment, the content source 210 and content receiver 220 are physically separated, each including separate housings. The content source 210 can be, for example, a game console, a DVD player, or a set-top box. The content receiver 220 can be, for example, a DVD player, a set-top box, or a television.

The first communication link 214a, second communication link 216, and third communication link 214c can be embodied as one or more wired or wireless communication links. For example, the communication links 214a, 214b, 216 can be a cable attached to an output port of the content source 210 and an input port of the content receiver 220. The communication links 214a, 214b, 216 can be one or more wireless communication links established according to one or more air interface standards. Thus, the content and motion information can be transmitted via an antenna of the content source 210 and received via an antenna of the content receiver 220.

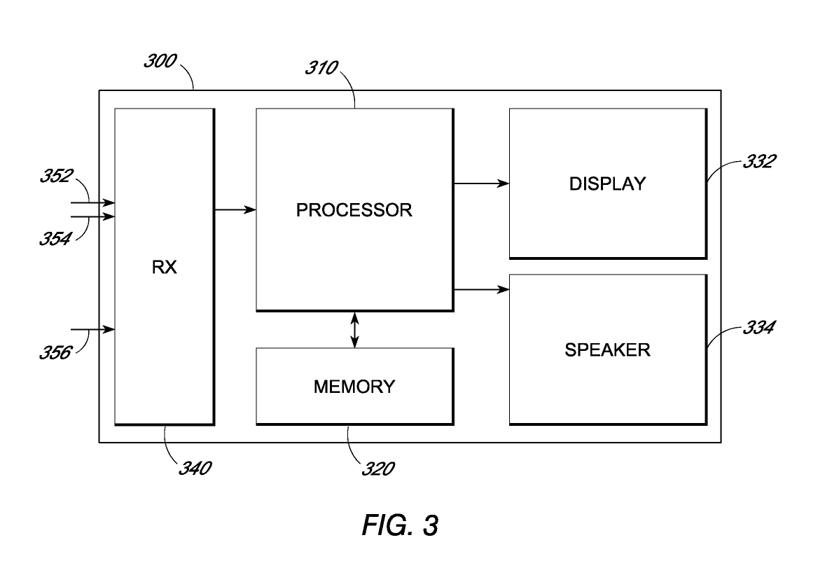

FIG. 3 is a functional block diagram illustrating an embodiment of a content receiver 300 that may be used in the system illustrated in FIG. 2. The content receiver 300 includes a processor 310, a memory 320, output devices including a display 332 and a speaker 334, and a receiver 340 which receives video content via a first communication link 352, audio content via a second communication link 356, and motion information associated with the video content via a third communication link 354.

Although described separately, it is to be appreciated that functional blocks described with respect to the content receiver 300 need not be separate structural elements. For example, the processor 310 and memory 320 may be embodied in a single chip. Similarly, the processor 310 and receiver 340 may be embodied in a single chip.

The processor 310 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 310 can be coupled, via one or more buses, to read information from or write information to the memory 320. The processor may additionally, or in the alternative, contain memory, such as processor registers. The memory 320 can include a processor cache, including a multi-level hierarchical cache in which different levels have different capacities and access speeds. The memory 320 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 310 is also coupled to output devices including a display 332 and a speaker 334 for, respectively, presenting video content and audio content. The content receiver 300 can also include one or more input devices and one or more additional output devices for, respectively, receiving input from and providing output to, a user of the content receiver 300. Suitable input devices include, but are not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, a microphone (possibly coupled to audio processing software to, e.g., detect voice commands), or an accelerometer. Suitable output devices include, but are not limited to, visual output devices, including displays and printers, audio output devices, including speakers, headphones, earphones, and alarms, and haptic output devices, including force-feedback game controllers and vibrating devices.

The processor 310 is further coupled to a receiver 340. The receiver 340 can be configured to demodulate data received via an input port or an antenna according to one or more data communication standards.

In one embodiment, the content receiver 300 and components thereof are powered by a battery and/or an external power source. The battery can be any device that stores energy, and particularly any device which stores chemical energy and provides it as electrical energy. The battery can include one or more secondary cells including a lithium polymer battery, a lithium ion battery, a nickel-metal hydride battery, or a nickel cadmium battery, or one or more primary cells including an alkaline battery, a lithium battery, a silver oxide battery, or a zinc carbon battery. The external power source can include a wall socket, a vehicular cigar lighter receptacle, a wireless energy transfer platform, or the sun. In some embodiments, the battery, or a portion thereof, is rechargeable by an external power source via a power interface. The power interface can include a jack for connecting a battery charger, an inductor for near field wireless energy transfer, or a photovoltaic panel for converting solar energy into electrical energy.

In one embodiment, the receiver 340 is configured to receive, at the content receiver 300 from a content source, input video having a first frame rate and motion information associated with the input video. The motion information can be, for example, motion vector information representative of the motion of objects or blocks between a first frame of video and a second frame of video. The input video can be received via the first communication link 352 and the motion vector information can be received via the third communication link 354.

In one embodiment, the processor 310 is configured to determine output video having a second frame rate different from the first frame rate, wherein the output video is based on the input video and the motion vector information. In one embodiment, the second frame rate is greater than the first frame rate. The output video can be, for example, frame rate converted video. Frame rate conversion based on motion vector information can be performed using a variety of algorithms, including, as non-limiting examples, those described in U.S. patent application Ser. No. 11/710,594, entitled “System and method for video noise reduction using an adaptive temporal method with motion detection and motion compensation,” filed Feb. 23, 2007; U.S. patent application Ser. No. 11/846,464, entitled “System and method for motion vector collection for motion compensated interpolation of digital video,” filed Aug. 28, 2007; U.S. patent application Ser. No. 12/436,650, entitled, “System and method for reducing visible halo in digital video with covering and uncovering detection,” filed May 6, 2009; and U.S. patent application Ser. No. 12/482,295, entitled “System and method for motion compensation using a set of candidate motion vectors obtained from digital video,” filed Jun. 10, 2009. The above-referenced U.S. patent applications are hereby incorporated by reference in their entirety.

In one embodiment, the display 332 is configured to display the output video after frame rate conversion. In one embodiment, the display 332 is configured to display the output video synchronously with presentation of the audio content via the speaker 334.

In one embodiment, the processor 310 is further configured to perform additional processing on the video content and/or the audio content, such as decompression, noise reduction, brightness/contrast adjustment, color adjustment, or other processing. In one embodiment, the content receiver is a television or a set-top box.

The first communication link 352, second communication link 356, and third communication link 354 can be embodied as one or more wired or wireless communication links. For example, the communication links 352, 354, 356 can be a cable attached to an input port of the content receiver 300. The communication links 352, 354, 356 can be one or more wireless communication links established according to one or more air interface standards. Thus, the content and motion information can be received via an antenna of the content receiver 300.

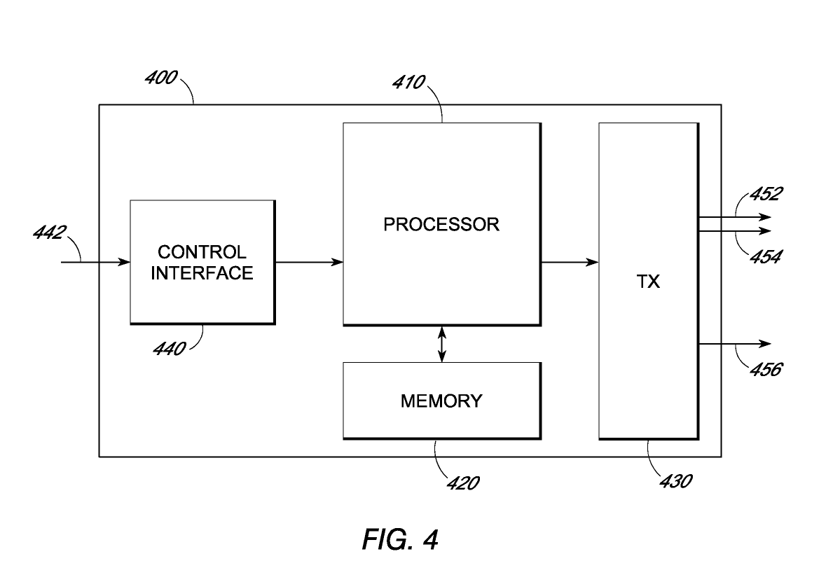

FIG. 4 is a functional block diagram illustrating an embodiment of a content source 400 that may be used in the system illustrated in FIG. 2. The content source 400 includes a processor 410, a memory 420, a transmitter 430, and a control interface 440. The user device 400 and components thereof are powered by a battery and/or an external power source as described above with respect to FIG. 3.

Although described separately, it is to be appreciated that functional blocks described with respect to the user device 400 need not be separate structural elements. For example, the processor 410 and memory 420 may be embodied in a single chip. Similarly, two or more of the processor 410, transmitter 430, and control interface 440 may be embodied in a single chip.

The processor 410 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 410 can be coupled, via one or more buses, to read information from or write information to memory 420. The processor may additionally, or in the alternative, contain memory, such as processor registers. The memory 420 can include a processor cache, including a multi-level hierarchical cache in which different levels have different capacities and access speeds. The memory 420 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 410 is coupled to a control interface 440 which receives data via a control communication link 442 indicative of user input. For example, the controller interface 440 can receive user instructions input via an input device, such as a game controller or an infrared remote control.

The processor 410 may also be coupled to one or more input devices and output devices for, respectively, receiving input from and providing output to, a user of the content source 400. Suitable input devices and output devices are described above with respect to FIG. 3.

The processor 410 is further coupled to a transmitter 430. The transmitter 430 prepares data generated by the processor 410 for transmission via one or more communication links 452, 454, 456.

In one embodiment, the processor is configured to generate video and motion information associated with the video. The motion information can be, for example, motion vector information representative of the motion of objects or blocks between a first frame of video and a second frame of video. The video can be transmitted, by the transmitter 430, via a first communication link 452 and the motion vector information can be transmitted, by the transmitter 430, via a third communication link 454. Audio content can be transmitted via a second communication link 456.

In one embodiment, the content source 400 is a game console which generates video based on programming stored in the memory 420 and user inputs received via the control interface 440.

The first communication link 452, second communication link 456, and third communication link 454 can be embodied as one or more wired or wireless communication links. For example, the communication links 452, 454, 456 can be a cable attached to an output port of the content source 400. The communication links 452, 454, 456 can be one or more wireless communication links established according to one or more air interface standards. Thus, the content and motion information can be transmitted via an antenna of the content source 400.

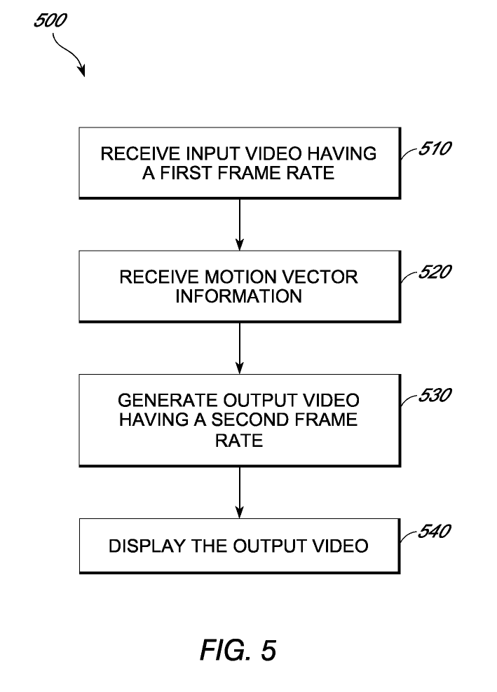

FIG. 5 is flowchart illustrating a method 500 of displaying video. The method 500 begins, in block 510, with the reception of input video having a first frame rate. The reception can be performed, for example, by the receiver 340 of FIG. 3. The input video can be received at a first device from a second device. For example, the input video can be received at the content receiver 220 from the content source 210 of FIG. 2. In one embodiment, the first device is a set-top box or a television and the second device is a gaming console.

Next, in block 520, motion vector information associated with the input video is received. The reception can be performed, for example, by the receiver 340 of FIG. 3. In one embodiment, the motion vector information includes data indicative of the relative locations of matching blocks in sequentially video frames of the input video. The motion vector information can be received at a first device from a second device. The first device and second device can be physically separated. In one embodiment, each of the first and second devices includes its own separate housing. For example, the motion vector information can be received at the content receiver 220 from the content source 210 of FIG. 2. In one embodiment, the first device is a set-top box or a television and the second device is a gaming console. In one embodiment, the motion vector information is received via a cable. For example, the motion vector information can be transmitted via an output port of the second device, via a cable, to an input port of the first device. In another embodiment, the motion vector information is received wirelessly. For example, the motion vector information can be transmitted via an antenna of the second device, via a wireless channel, to an antenna of the first device.

Although blocks 510 and 520 are illustrated sequentially, it is to be appreciated that the steps associated with blocks 510 and 520 can be performed in reverse order, simultaneously, or overlapping in time.

The method 500 continues in block 530 with the generation of output video having a second frame rate. The generation can be performed, for example, by the processor 310 of FIG. 3. The output video can be generated based on the received input video and the received motion vector information. In one embodiment, the second frame rate is greater than the first frame rate. In one embodiment, the output video is frame rate converted video of the input video. Accordingly, in one embodiment, the output video comprises interpolated video frames. Finally, in block 540, the output video is displayed. The display can be performed, for example, by the display 332 in FIG. 3.

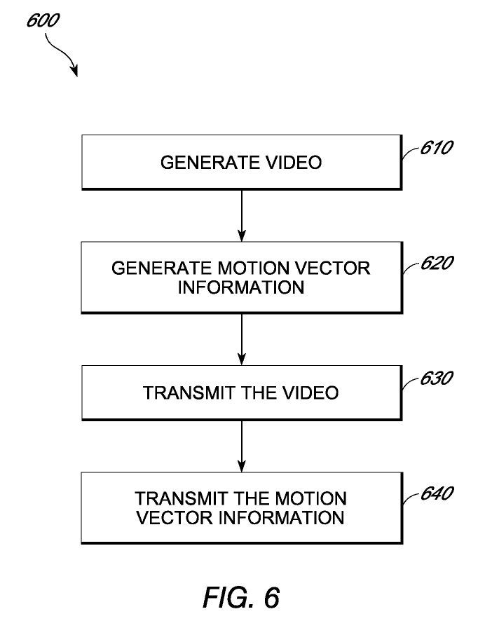

FIG. 6 is a flowchart illustrating a method 600 of transmitting motion information. The method 600 begins in block 610 with the generation of video. The generation of video can be performed, for example, by the processor 410 of FIG. 4. In one embodiment, the video is generated in real-time based on data indicative of user instructions received via a controller and/or software stored on a computer-readable medium. Next, in block 620, motion vector information associated with the video is generated. The generation of motion vector information can be performed, for example, by the processor 410 of FIG. 4. In one embodiment, the motion vector information includes data indicative of the relative locations of matching blocks in sequential video frames of the input video. In one embodiment, the motion vector information is generated in real-time based on data indicative of user instructions received via a controller and/or software stored on a computer-readable medium.

The method continues in block 630 with the transmission of the generated video. The video can be transmitted, for example, by the transmitter 430 of FIG. 4. The generated video can be transmitted from a first device to a second device. For example, the generated video can be transmitted from the content source 210 to the content receiver 220 of FIG. 2. In one embodiment, the first device is a gaming console and the second device is a set-top box or a television.

Next, in block 640, the generated motion vector information is transmitted. The transmission can be performed, for example, by the transmitter 430 of FIG. 4. The motion vector information can be transmitted from a first device to a second device. The first device and second device can be physically separated. In one embodiment, each of the first and second devices includes its own separate housing. For example, the motion vector information can be transmitted from the content source 210 to the content receiver 220 of FIG. 2. In one embodiment, the first device is a gaming console and the second device is a set-top box or a television. In one embodiment, the motion vector information is transmitted via a cable. For example, the motion vector information can be transmitted from an output port of the first device, via a cable, to an input port of the second device. In another embodiment, the motion vector information is transmitted wirelessly. For example, the motion vector information can be transmitted from an antenna of the first device, via a wireless channel, to an antenna of the second device.

Although blocks 610 and 620 are illustrated sequentially, it is to be appreciated that the steps associated with blocks 610 and 620 can be performed in reverse order, simultaneously, or overlapping in time. Similarly, although blocks 630 and 640 are illustrated sequentially, it is to be appreciated that the steps associated with blocks 630 and 640 can be performed in reverse order, simultaneously, or overlapping in time.

While the specification describes particular examples of the present invention, those of ordinary skill can devise variations of the present invention without departing from the inventive concept. Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. The terms signal and threshold can depend upon the signal modulation technique. If Pulse Amplitude Modulation (PAM) is used then the voltage amplitude or power of the signal represents its value. In that case the threshold is simply a power value. If Phase Shift Keying is used, then the phase of the signal, which can translate to the sign of the received signal voltage can represent the signal value. In this case if the signal is integrated over multiple symbols, then the sign and amplitude of the received signal together indicate the signal value.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A method of displaying video, the method comprising:
receiving, at a first device from a second device, input video having a first frame rate;
receiving, at the first device from the second device, motion vector information associated with the input video;
generating, at the first device, output video having a second frame rate different from the first frame rate, wherein the output video is based on the input video and the motion vector information; and
displaying the output video.

2. The method of claim 1, wherein the first device and the second device are physically separated.

3. The method of claim 1, wherein the first device is a television or set-top box.

4. The method of claim 1, wherein the second device is a gaming console.

5. The method of claim 1, wherein receiving motion vector information comprises receiving motion vector information via an input port.

6. The method of claim 1, wherein receiving motion vector information comprises receiving motion vector information via a cable.

7. The method of claim 1, wherein receiving motion vector information comprises receiving motion vector information via an antenna.

8. The method of claim 1, wherein the second frame rate is greater than the first frame rate.

9. The method of claim 1, wherein the received input video is uncompressed.

10. A method of transmitting motion vector information, the method comprising:
generating video at a first device;
generating motion vector information associated with the video at the first device;
transmitting the video from the first device to a second device; and
transmitting the motion vector information from the first device to the second device.

11. The method of claim 10, wherein the first device and the second device are physically separated.

12. The method of claim 10, wherein the first device is a gaming console.

13. The method of claim 10, wherein the second device is a television or set-top box.

14. The method of claim 10, wherein generating the video and generating the motion vector information is based on user instructions received via a controller.

15. The method of claim 10, wherein transmitting the motion vector information comprises transmitting the motion vector information via an output port.

16. The method of claim 10, wherein transmitting the motion vector information comprises transmitting the motion vector information via a cable.

17. The method of claim 10, wherein transmitting the motion vector information comprises transmitting the motion vector information via an antenna.

18. The method of claim 10, wherein the transmitted video is uncompressed.

19. A first device for displaying video, the first device comprising:
a receiver configured to receive, at the first device from a second device, input video having a first frame rate and motion vector information associated with the input video;
a processor configured to generate output video having a second frame rate different from the first frame rate, wherein the output video is based on the input video and the motion vector information; and
a display configured to display the output video.

20. The first device of claim 19, wherein the first device and the second device are physically separated.

21. The first device of claim 19, wherein the first device is a television or set-top box.

22. The first device of claim 19, wherein the receiver comprises an input port configured to receive a cable.

23. The first device of claim 19, wherein the receiver comprises an antenna.

24. The first device of claim 19, wherein the second frame rate is greater than the first frame rate.

25. The first device of claim 19, wherein the receive is configured to receive uncompressed video.

26. A first device for transmitting motion vector information, the first device comprising:
a processor configured to generate video and motion vector information associated with the video; and
a transmitter configured to transmit the video and the motion vector information from the first device to a second device.

27. The first device of claim 26, wherein the first device and the second device are physically separated.

28. The first device of claim 26, wherein the first device is a gaming console.

29. The first device of claim 26, further comprising a controller configured to transmit data indicative of user instructions to the processor and wherein the processor is configured to generate video and motion vector information based on user instructions.

30. The first device of claim 26, wherein the transmitter comprises an output port configured to receive a cable.

31. The first device of claim 26, wherein the transmitter comprises an antenna.

32. The first device of claim 26, wherein the transmitted is configured to transmit uncompressed video.

33. A first device for displaying video, the first device comprising:
means for receiving, at the first device from a second device, input video having a first frame rate;
means for receiving, at the first device from the second device, motion vector information associated with the input video;
means for generating, at the first device, output video having a second frame rate different from the first frame rate, wherein the output video is based on the input video and the motion vector information; and
means for displaying the output video.

34. The first device of claim 29, wherein the means for receiving comprises an input port configured to receive a cable or the means for receiving comprises an antenna.

35. The first device of claim 29, wherein the means for determining comprises a processor.

36. A first device for transmitting motion vector information, the first device comprising:
means for generating video at the first device;
means for generating motion vector information associated with the video at the first device;
means for transmitting the video from the first device to a second device; and
means for transmitting the motion vector information from the first device to the second device.

37. The first device of claim 32, wherein the means for transmitting the motion vector information comprises an output port configured to receive a cable or the means for transmitting the motion vector information comprises an antenna.

38. The first device of claim 32, wherein the means for generating video comprises a processor.

39. A computer-readable storage medium having processor-executable instructions encoded thereon which, when executed by a processor, cause a first device to perform a method of displaying video, the method comprising:
receiving, at the first device from a second device, input video having a first frame rate;
receiving, at the first device from the second device, motion vector information associated with the input video;
generating, at the first device, output video having a second frame rate different from the first frame rate, wherein the output video is based on the input video and the motion vector information; and
displaying the output video.

40. A computer-readable storage medium having processor-executable instructions encoded thereon which, when executed by a processor, cause a first device to perform a method of transmitting motion vector information, the method comprising:
generating video at the first device;
generating motion vector information associated with the video at the first device;
transmitting the video from the first device to a second device; and
transmitting the motion vector information from the first device to the second device.
